(19) United States
(12) Patent Application Publication
(10) Pub. No.: US 2017/0329472 A1
(43) Pub. Date: Nov. 16, 2017

(54) ELECTRONIC DEVICE AND METHOD OF PROVIDING INFORMATION IN ELECTRONIC DEVICE

(71) Applicant: Samsung Electronics Co., Ltd., Gyeonggi-do (KR)

(72) Inventors: Young-Mi KIM, Seoul (KR); Jeong-Won KO, Seoul (KR); Young-Seong KIM, Seoul (KR); Myoung-Soo PARK, Gyeonggi-do (KR); Jung-Woo SHIN, Gyeonggi-do (KR); Hae-Mi YOON, Seoul (KR); Kyung-Jun LEE, Gyeonggi-do (KR); Hyun-Yeul LEE, Seoul (KR)

(21) Appl. No.: 15/592,328

(22) Filed: May 11, 2017

(30) Foreign Application Priority Data
May 12, 2016 (KR) 10-2016-0058432

(51) Int. Cl. G06F 3/0482; G06F 3/0488; G06F 3/0481

(52) U.S. Cl. CPC G06F 3/0482; G06F 3/04817; G06F 3/0488

(57) ABSTRACT

Provided are an electronic device and a method of providing information in an electronic device. The electronic device may include a display and a processor, and the processor may be configured to control the display to display an application guidance screen including at least one application execution object corresponding to at least one application, in response to a first input; control the display to display a notification event for an application execution object from among the at least one application execution object; in response to a second input selecting the application execution object, control the display to display information related to the notification event on a preview screen; and in response to a third input selecting the information related to the notification event, execute an application corresponding to the application execution object.

### CLAIM OF PRIORITY

This application claims the priority under 35 U.S.C. §119(a) to Korean Application Serial No. 10-2016-0058432, which was filed in the Korean Intellectual Property Office on May 12, 2016, the entire content of which is hereby incorporated by reference.

### TECHNICAL FIELD

The present disclosure relates to an electronic device and a method of providing information in the electronic device.

### BACKGROUND

Electronic devices may provide various types of information through various programs or applications. Such an electronic device may display, on a display such as a touchscreen, objects (e.g. icons, shortcut images, and/or widgets) that allow convenient execution of functions of stored applications or programs.

For example, electronic devices, such as a smart phone or the like, may display an object corresponding to an application set by a user on a home screen.

### SUMMARY

When updated information is generated in an application, an electronic device may display an object indicating the updated information by displaying, for example, a notification linked to the icon of the corresponding application.

Also, when a user selects (e.g., touches or long-touches) an object of an application displayed on the display, the electronic device immediately executes a corresponding application.

However, the electronic device may display only an object (e.g., an icon) for the corresponding application and information (e.g., a numerical indicator) indicating the occurrence of updated information on a current screen, and may not provide additional information associated with the updated information. Therefore, the user needs to access the information through various stages (depth) or with additional navigation, which may be burdensome.

In other implementations, when new information is generated or received in association with a corresponding application, the electronic device may display the new information only after the application is executed, such as when the object (e.g. icon) associated with the application is selected. Accordingly, the user may not be able to view the new information unless he or she selects the application for execution, which may be burdensome on the user.

Therefore, various embodiments of the present disclosure provide an electronic device and a method for conveniently providing new information related an application.

According to one or more embodiments of the present disclosure, there is provided an electronic device, including a display and a processor, and the processor is configured to control the display to display an application guidance screen including at least one application execution object corresponding to at least one application, in response to a first input; control the display to display a notification event for an application execution object from among the at least one application execution object; in response to a second input selecting the application execution object, control the display to display information related to the notification event on a preview screen; and in response to a third input selecting the information related to the notification event, execute an application corresponding to the application execution object.

According to one or more embodiments of the present disclosure, there is provided a method of providing information in an electronic device, the method including: displaying an application guidance screen including at least one application execution object corresponding to at least one application, in response to a first input; displaying a notification event for an application execution object from among the at least one application execution object; in response to a second input selecting the application execution object, displaying information related to the notification event on a preview screen; and in response to a third input selecting the information related to the notification event, executing an application corresponding to the application execution object.

According to embodiments of the present disclosure, there is provided a computer-readable recording medium which records a program to be implemented on a computer, wherein the program includes one or more executable commands to enable a processor to perform: displaying an application guidance screen including at least one application execution object corresponding to at least one application, in response to a first input; displaying a notification event for an application execution object from among the at least one application execution object; in response to a second input selecting an application execution object, displaying information related to the notification event on a preview screen; and in response to a third input selecting the information related to the notification event, executing an application corresponding to the application execution object.

According to an electronic device and a method for providing information in an electronic device according to one or more embodiments, the electronic device may display an application guidance screen in at least a part of the display, and when a predetermined input is received for an application execution object in which a notification event has occurred, the electronic device may display information related to the notification event through a preview screen instead of having to execute the corresponding application. Accordingly, the corresponding application may not need to be executed to display updated information every time updated information is generated or received.

Therefore, the electronic device according to the present disclosure can conveniently and promptly display information about an application.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates a network environment according to one embodiment of the present disclosure;

FIG. 2 is a block diagram illustrating an example of a configuration of an electronic device according to one embodiment of the present disclosure;

FIG. 3 is a flowchart illustrating an operation process of an electronic device according to one embodiment of the present disclosure;

FIG. 4A, FIG. 4B and FIG. 4C illustrate examples of screens of an electronic device according to one embodiment of the present disclosure;

FIG. 5A, FIG. 5B, FIG. 5C and FIG. 5D illustrate examples of screens of an electronic device according to one embodiment of the present disclosure;

FIG. 6 illustrates an example of a screen of an electronic device according to one embodiment of the present disclosure;

FIG. 7A, FIG. 7B and FIG. 7C illustrate examples of screens of an electronic device according to one embodiment of the present disclosure;

FIG. 8 illustrates an example of a screen of an electronic device according to one embodiment of the present disclosure;

FIG. 9 illustrates an example of a screen of an electronic device according to one embodiment of the present disclosure;

FIG. 10 is a block diagram of an electronic device according to one embodiment; and

FIG. 11 is a block diagram of a program module according to one embodiment.

### DETAILED DESCRIPTION

Hereinafter, various embodiments of the present disclosure will be described with reference to the accompanying drawings. The embodiments and the terms used therein are not intended to limit the technology disclosed herein to specific forms, and should be understood to include various modifications, equivalents, and/or alternatives to the corresponding embodiments. In describing the drawings, similar reference numerals may be used to designate similar constituent elements. A singular expression may include a plural expression unless they are definitely different in a context. As used herein, singular forms may include plural forms as well unless the context clearly indicates otherwise. The expression “a first,” “a second,” “the first,” or “the second” used in various embodiments of the present disclosure may modify various components regardless of the order and/or the importance but does not limit the corresponding components. When an element (e.g., first element) is referred to as being “(functionally or communicatively) connected,” or “directly coupled” to another element (second element), the element may be connected directly to the another element or connected to the another element through yet another element (e.g., third element).

The expression “configured to” as used in various embodiments of the present disclosure may be interchangeably used with, for example, “suitable for,” “having the capacity to,” “designed to,” “adapted to,” “made to,” or “capable of” in terms of hardware or software, according to circumstances. Alternatively, in some situations, the expression “device configured to” may mean that the device, together with other devices or components, “is able to.” For example, the phrase “processor adapted (or configured) to perform A, B, and C” may mean a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit). In some embodiments, the electronic device may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and Play Station™), an electronic dictionary, an electronic key, a camcorder, and an electronic photo frame.

In other embodiments, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.). According to some embodiments, an electronic device may include at least one of a part of furniture or a building/structure, an electronic board, an electronic signature receiving device, a projector, and various types of measuring instruments (e.g., a water meter, an electric meter, a gas meter, a radio wave meter, and the like). In various embodiments, the electronic device may be flexible, or may be a combination of one or more of the aforementioned various devices. The electronic device according to one embodiment of the present disclosure is not limited to the above described devices. In the present disclosure, the term “user” may indicate a person using an electronic device or a device (e.g., an artificial intelligence electronic device) using an electronic device.

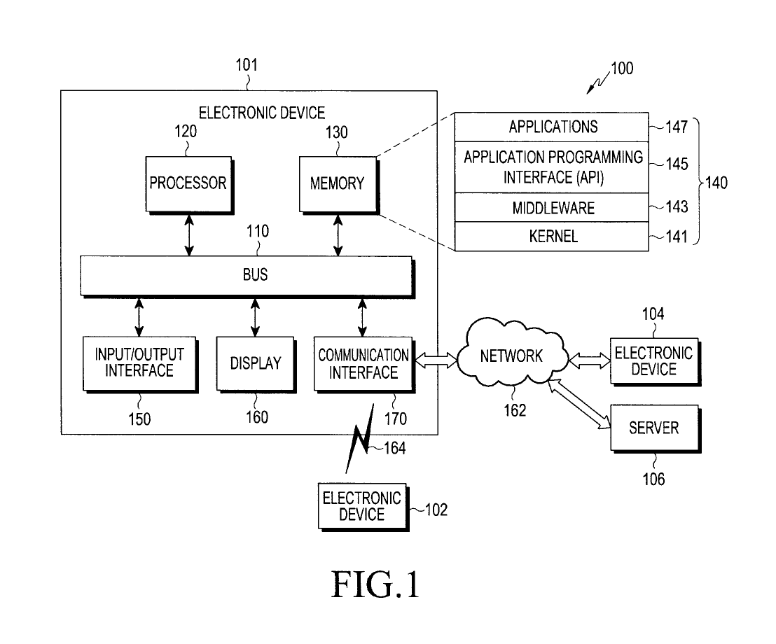

Referring to FIG. 1, an electronic device 101 in a network environment 100 according to one embodiment will be described. The electronic device 101 may include a bus 110, a processor 120, a memory 130, an input/output interface 150, a display 160, and a communication interface 170. According to an embodiment, the electronic device 101 may omit at least one of the elements, or may further include other elements. The bus 110 may include, for example, a circuit that interconnects the elements 110 to 170 and transfers communication (e.g., control messages and/or data) between the elements. The processor 120 may include one or more of a central processing unit, an application processor, and a communication processor (CP). The processor 120, for example, may carry out operations or data processing relating to the control and/or communication of at least one other element of the electronic device 101.

The memory 130 may include a volatile and/or non-volatile memory. The memory 130 may store, for example, instructions or data relevant to at least one other element of the electronic device 101. According to an embodiment, the memory 130 may store software and/or a program 140. The program 140 may include, for example, a kernel 141, middleware 143, an application programming interface (API) 145, and/or application programs (or “applications”) 147. At least some of the kernel 141, the middleware 143, or the API 145 may be referred to as an operating system. The kernel 141 may control or manage system resources (e.g., the bus 110, the processor 120, the memory 130, or the like) used for executing an operation or function implemented by other programs (e.g., the middleware 143, the API 145, or the application 147). Also, the kernel 141 may provide an interface through which the middleware 143, the API 145, or the application programs 147 may access the individual elements of the electronic device 101 to control or manage the system resources.

The middleware 143 may function as, for example, an intermediary for allowing the API 145 or the application programs 147 to communicate with the kernel 141 to exchange data. Furthermore, the middleware 143 may process one or more task requests, which are received from the application programs 147, according to the priority thereof. For example, the middleware 143 may assign one or more of the application programs 147 priority to use the system resources (e.g., the bus 110, the processor 120, the memory 130, or the like) of the electronic device 101, and may process the one or more task requests. The API 145 is an interface used by the application 147 to control a function provided from the kernel 141 or the middleware 143, and may include, for example, at least one interface or function (e.g., an instruction) for file control, window control, image processing, character control, or the like. For example, the input/output interface 150 may forward instructions or data, input from a user or an external device, to the other element(s) of the electronic device 101, or may output instructions or data, received from the other element(s) of the electronic device 101, to the user or the external device.

The display 160 may include, for example, a liquid crystal display (LCD), a light-emitting diode (LED) display, an organic light-emitting diode (OLED) display, a micro electro mechanical system (MEMS) display, or an electronic paper display. The display 160 may display, for example, various types of content (e.g., text, images, videos, icons, and/or symbols) for a user. The display 160 may include a touch screen, and may receive, for example, a touch, gesture, proximity, or hovering input using an electronic pen or the user's body part. The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication to communicate with the external device (e.g., the second external electronic device 104 or the server 106).

The wireless communication may include cellular communication that uses at least one of LTE, LTE-Advanced (LTE-A), code division multiple access (CDMA), wideband CDMA (WCDMA), universal mobile telecommunications system (UMTS), wireless broadband (WiBro), global system for mobile communications (GSM), or the like. According to an embodiment, the wireless communication may include, for example, at least one of Wi-Fi, Bluetooth, Bluetooth low energy (BLE), ZigBee, nearfield communication (NFC), magnetic secure transmission, radio frequency (RF), and body area network (BAN). According to an embodiment, the wireless communication may include GNSS. The GNSS may be, for example, a global positioning system (GPS), a global navigation satellite system (Glonass), a Beidou navigation satellite system (hereinafter, referred to as “Beidou”), or Galileo (the European global satellite-based navigation system). Hereinafter, in this document, the term “GPS” may be interchangeable with the term “GNSS”. The wired communication may include, for example, at least one of a universal serial bus (USB), a high-definition multimedia interface (HDMI), recommended standard 232 (RS-232), power-line communication, and a plain old telephone service (POTS). The network 162 may include a telecommunications network, for example, at least one of a computer network (e.g., a LAN or a WAN), the Internet, and a telephone network.

Each of the first and second external electronic devices 102 and 104 may be of a type that is the same as or different from that of the electronic device 101. According to one embodiment, all or some of the operations executed in the electronic device 101 may be executed in another electronic device or a plurality of electronic devices (e.g., the electronic devices 102 and 104 or the server 106). According to an embodiment, when the electronic device 101 has to perform some functions or services automatically or by request, the electronic device 101 may make a request for performing at least some functions relating thereto to another device (e.g., the electronic device 102 or 104 or the server 106) instead of or in addition to performing the functions or services by itself. Another electronic device (e.g., the electronic device 102 or 104, or the server 106) may execute the requested functions or the additional functions, and may deliver the result of execution to the electronic device 101. The electronic device 101 may provide the received result as it is, or may additionally process the received result to provide the requested functions or services. To this end, for example, cloud computing, distributed computing, or client-server computing technology may be used.

Hereinafter, an electronic device according to one or more embodiments of the present disclosure will be described with reference to the accompanying drawings.

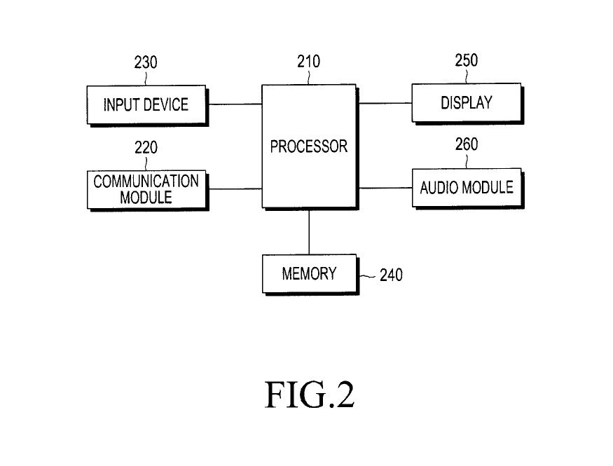

FIG. 2 is a block diagram illustrating an example of a configuration of an electronic device according to one embodiment of the present disclosure.

Referring to FIG. 2, according to one embodiment of the present disclosure, an electronic device 200 (e.g., the same as or similar to the electronic device 101 of FIG. 1) may include at least one of a processor 210, a communication module 220, an input device 230, a memory 240, a display 250, and an audio module 260.

According to one embodiment of the present disclosure, the processor 210 (e.g., the same as or similar to the processor 120 of FIG. 1) may process information associated with the operation of the electronic device 200, and information associated with the execution of a program, an application, or a function. The processor 210 may also control the display 250 to display the processed information in the display 250 or to output the processed information as audio information through the audio module 260. The processor 210 may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for.” In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

The processor 210 may control the display 250 to display an application guidance screen (e.g., an application leaflet, described below) including at least one application execution object (e.g., at least one of an icon, a shortcut image, and a widget) corresponding to at least one application, in a partial area or the entire area of the display 250. For example, when a predetermined gesture input (e.g., at least one of a swipe input from left to right, a multi-touch input, and a double-touch input) is received, the processor 210 may gradually display the application guidance screen by gradually moving the application guidance screen into view from a left edge of the display 250.

When a notification event occurs in association with the occurrence of new information for an application execution object displayed on the application guidance screen, the processor 210 may control the display 250 to display, in an area adjacent to or associated with the application execution object, a notification object (e.g., an indicator such as a numerical indicator) indicating that the new information has occurred in the application. In one embodiment, the processor 210 may display application execution objects in the form of a list on the application guidance screen. Here, the application execution objects displayed on the application guidance screen may correspond to at least one out of: applications that are executed recently by a user; applications having high frequencies of use; applications selected by the user to be displayed in the application guidance screen; and applications that are automatically displayed in the application guidance screen in association with a predetermined function of the electronic device.

When an input is received for the application execution object for which the notification event has occurred, the processor 210 may display a preview screen displaying information related to the notification event in at least a partial area of the application guidance screen. Here, the processor 210 may display the preview screen in a manner such that other objects displayed in the application guidance screen are not covered or obscured by the newly displayed preview screen. That is, when the preview screen is displayed, the processor 210 may perform operations to move application execution objects that would be covered or obscured by the preview screen to an area that is not covered by the preview screen on the application guidance screen. For example, when some of the application execution objects displayed in the form of a list are covered or would be covered by the preview screen when the preview screen is displayed, the processor 210 may move the covered application execution objects to an area where the preview screen is not displayed.

When an input (e.g., a long-press input, a double-touch input, or a multi-touch input) associated with selecting the application execution object for which the notification event has occurred is received on the application guidance screen, the processor 210 may display brief information related to the notification event on the preview screen. Also, when another input (e.g., a gesture of performing a multi-touch input such as a gesture of spreading two fingers) is received on the displayed preview screen, the processor 210 may display detailed information related to the notification event on an extended preview screen. Here, the extended preview screen in which the detailed information is displayed may be a screen obtained by extending the size of the preview screen that displays the brief information. In addition, the extended preview screen may display additional objects such as icons to provide a few functions of the application corresponding to the application execution object, so that the user can more conveniently access functions of the application on the extended preview screen, without having to execute the entire application.

When a piece of notification event-related information displayed on the preview screen receives a selection input, for example a touch input, the processor 210 may execute the application that corresponds to the application execution object. When the corresponding application is executed, the processor 210 may display the application execution screen associated with the application on the display 250. For example, when the corresponding executed application is an application associated with transmission/reception of a message, the processor 210 may display the execution screen of a message application. However, for example, when the executed application is an application related to reproduction of audio information, for example a music player, the processor 210 may not display an execution screen associated with the music player, but rather may only output audio information through the audio module 260. Accordingly, when the music player, for example, is executed, the user may select another application execution object in the application guidance screen and the processor 210 may display the execution screen of another application on the display 250, for example the execution screen of a message application.

In one embodiment, when an input signal selecting an application execution object displayed on the application guidance screen is received, for example, the processor 210 may not display a preview screen, and may immediately execute the application corresponding to the application execution object.

According to one or more embodiments of the present disclosure, the communication module 220 (e.g., the communication interface 170 of FIG. 1) of the electronic device may perform communication with an external electronic device (e.g., the electronic device 102 or 104 of FIG. 1 or the server 106) according to the control of the processor 210. According to one embodiment, the communication module 220 may transmit or receive, to/from an external electronic device, data related to operations executed according to the control of the processor 210. The communication module 220 may perform communication through a connection between devices or through a connection to a network using wireless communication or wired communication through a communication interface. The wireless communication may include at least one of, for example, Wi-Fi, Bluetooth (BT), ZigBee, Z-Wave, nearfield communication (NFC), global positioning system (GPS) and cellular communication (e.g., LTE, LTE-A, CDMA, WCDMA, UMTS, WiBro, GSM or the like). The wired communication may include at least one of a universal serial bus (USB), a high-definition multimedia interface (HDMI), recommended standard 232 (RS-232), a plain old telephone service (POTS), a universal asynchronous receiver transmitter (UART), an inter-integrated circuit (I2C), a serial peripheral interface (SPI), and a controller area network (CAN). Also, the communication module 220 may include communication schemes of all types that have been publicly known or will be developed in the future, in addition to the above described communication schemes.

According to one embodiment of the present disclosure, the communication module 220 may receive, from an external electronic device, new information associated with at least one application execution object displayed on the application guidance screen, and may transmit the received new information to the processor 210. Also, the communication module 220 may transmit or receive information associated with an application executed by the processor 210.

According to one embodiment of the present disclosure, the input unit 230 of the electronic device (e.g., which may be the same or similar to the input/output interface 150 of FIG. 1) may transfer, to the processor 210, various pieces of information such as number and character information input from a user, various function settings, and signals which are input in connection with control of functions of the electronic device. Also, the input device 230 may support a user input for executing a module or an application that supports a predetermined function. The input device 230 may include at least one out of: a key input unit, such as a keyboard, a keypad, or the like; a touch input unit, such as a touch sensor or a touch pad; a sound source input unit; a camera; and various sensors, and may include a gesture input unit. In addition, the input unit 230 may include all types of input units which are being developed currently or will be developed in the future. Also, according to one embodiment of the present disclosure, the input device 230 may receive information through a touch panel or a camera of the display 250 from the user, and may transmit the input information to the processor 210.

According to one embodiment of the present disclosure, the input device 230 may transmit information associated with a user's gesture received through the touch panel or various sensors to the processor 210. Also, the input device 230 may transmit an input signal for selecting at least one application execution object (e.g., an icon, a shortcut, or a widget), displayed on the application guidance screen, to the processor 210. Also, the input device 230 may receive an input signal for displaying an application guidance screen in a part or the entirety of a currently displayed screen (e.g., a home screen), and may transmit the input signal to the processor 210. Also, the input device 230 may transmit an input signal for selecting at least one piece of notification event-related information displayed on the application guidance screen in the application guidance screen, to the processor 210.

Also, according to one embodiment of the present disclosure, the input device 230 may receive an input signal for executing a function from a user through a sound source input unit (e.g., a microphone), and may transmit the input signal to the processor 210.

According to one or more embodiments of the present disclosure, the memory 240 (e.g., which may be the same or similar to the memory 130 of FIG. 1) of the electronic device may temporarily or permanently store various data that are generated while a program is executed, in addition to a program that is required for operating a function according to various embodiments. The memory 240 may largely include a program area and a data area. The program area may store pieces of information related to driving of an electronic device such as an operating system (OS) of the electronic device. The data area may store transmitted/received data or generated data according to various embodiments. Further, the memory 240 may include at least one storage medium out of: a flash memory; a hard disk; a multimedia card micro type memory (e.g., an SD or XD memory); a RAM; and a ROM. According to one embodiment, the memory 240 may store information for communicating with an external electronic device and transmitted and received data. According to one embodiment, the memory 240 may store notification event-related information.

According to one or more embodiments of the present disclosure, the display 250 of the electronic device (e.g., the display 160 or a partial configuration of the input/output interface 150 of FIG. 1) may output operation execution result information (e.g., at least one of text, an image, and a video) according to the control of the processor 210.

According to one embodiment of the present disclosure, the display 250 may display, in various manners, an input pad through which various characters, numbers, or symbols can be inputted. Also, the display 250 may display an application execution screen in association with execution of various applications. According to one embodiment, the display 250 may display an application guidance screen that displays at least one application execution object according to the control of the processor 210. Also, when an input signal for an application execution object in which a notification event has occurred is received on the application guidance screen, the display 250 may display a preview screen on the application guidance screen according to the control of the processor 210. Here, the preview screen may display brief information related to the notification event. Also, when at least one piece of information displayed in the preview screen is selected, the display 250 may display an application execution screen including information related to the notification event according to the control of the processor 210.

Also, according to one embodiment of the present disclosure, when the display 250 of the electronic device is a touch screen, the display 250 may include a touch panel, which is a part of the input device 230. When the display 250 is a touch screen, together with the input device 230, the display 250 may display various pieces of information generated according to touch operations of a user.

According to one or more embodiments, the display unit 250 of the electronic device may be formed of at least one of a liquid crystal display (LCD), a thin film transistor LCD (TFT-LCD), an organic light-emitting diode (OLED), LED, active matrix OLED (AMOLED), a flexible display, and a 3-dimensional display. Some of the displays may be formed as a transparent type or a light-transmissive type so that the outside can be seen therethrough. The display may be formed as a transparent display form including transparent OLED (TOLED). Also, according to one or more embodiments of the present disclosure, the electronic device may further include another installed display unit (e.g., an extended display unit or a flexible display unit) and a display unit of an external electronic device that interoperates with the electronic device (e.g., an external display device, a wearable device, or an external terminal device), in addition to the display 250.

According to one or more embodiments of the present disclosure, the audio module 260 (e.g., the output interface 150 of FIG. 1) of the electronic device 200 may output sound (audio information), and may include at least one of, for example, an audio codec, a microphone (MIC), a receiver, an earphone, and a speaker.

According to one or more embodiments, when an application execution object for which a notification event associated with new information s selected, the audio module 260 of the electronic device may output notification event-related information as audio information. Also, the audio module 260 may output audio information that is generated while an application is executed.

Also, according to one or more embodiments of the present disclosure, the electronic device may further include a unit for outputting a vibration or a unit for outputting a scent. The unit for outputting a vibration or the unit for outputting a scent may output, as a vibration or scent, at least one of information generated as each application is executed, information about the occurrence of a notification event, and information associated with a notification event that has occurred.

As described above, one or more embodiments of the present disclosure have been described to elucidate major elements of the electronic device according to the present disclosure. However, in one or more embodiments of the present disclosure, the electronic device may include fewer or more elements when compared to the elements of FIG. 2. Also, the major elements of the electronic device which have been described through FIG. 2 may be changeable according to the present disclosure.

An electronic device according to any one of various embodiments of the present disclosure may include a display and a processor. The processor may be configured to control the display to display an application guidance screen including at least one application execution object corresponding to at least one application, in response to a first input; control the display to display a notification event for an application execution object from among the at least one application execution object; in response to a second input selecting the application execution object, control the display to display information related to the notification event on a preview screen; and in response to a third input selecting the information related to the notification event, execute an application corresponding to the application execution object.

According to one or more embodiments of the present disclosure, when the application is executed, the processor may be further configured to control to display an execution screen of the application including new information corresponding to the information related to the notification event.

According to one or more embodiments of the present disclosure, the processor may be further configured to, in response to a fourth input, control the display to display detailed information related to the notification event.

According to one or more embodiments of the present disclosure, the processor may be further configured to, in response to the fourth input, control the display to display an extended preview screen where the detailed information related to the notification event is displayed, wherein the extended preview screen comprises one or more objects corresponding to one or more functions of the application.

According to one or more embodiments of the present disclosure, when a plurality of application execution objects are displayed on the application guidance screen, the processor may be further configured to rearrange a display location of at least one of the plurality of application execution objects that is covered by the preview screen.

According to one or more embodiments of the present disclosure, the processor may be further configured to: when another notification event occurs in a state in which the preview screen is displayed on the application guidance screen, determine another application execution object corresponding to the another notification event; control the display to display the another notification event for the another application execution object; and in response to a fifth input selecting the another application execution object, control the display to display information related to the another notification event on another preview screen.

According to one or more embodiments of the present disclosure, the another preview screen is displayed together with the preview screen.

According to one or more embodiments of the present disclosure, when the executed application is related to reproduction of audio information, the processor may be further configured to play back audio information associated with the notification event in a state in which the preview screen is displayed.

According to one or more embodiment of the present disclosure, when a single touch input selecting an application execution object from among the at least one application execution object is received on the application guidance screen, the processor executes an application corresponding to the application execution object.

An operation procedure in which an electronic device provides information as described above will be described in detail below.

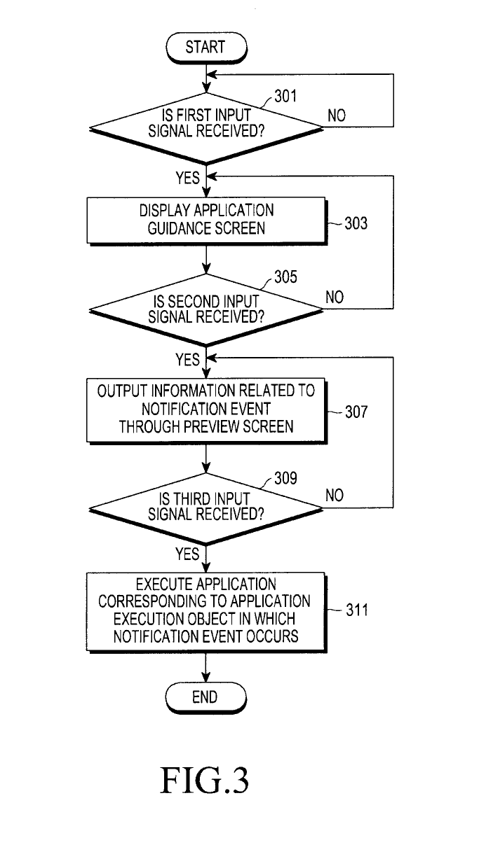

FIG. 3 is a flowchart of an operation procedure of an electronic device according to one embodiment of the present disclosure.

Referring to FIG. 3, an electronic device (e.g., the electronic device 101 of FIG. 1 or the electronic device 200 of FIG. 2) according to one embodiment of the present disclosure may display, for example, a home screen or a predetermined application execution screen.

When the home screen or the predetermined application execution screen is currently displayed in a display of the electronic device, the electronic device determines whether a first input is received on the current screen in operation 301.

When the first input is received on the current screen, the electronic device proceeds with operation 303. When the first input signal is not received, the electronic device maintains the state of displaying the current screen. Here, the first input may be a gesture operation (e.g., at least one of a swipe input, a double-touch input, and a long-touch input) or a button input, which is set to display an application guidance screen.

In operation 303, when the electronic device recognizes that the first input is received on the current screen, the electronic device displays the application guidance screen. Here, the application guidance screen may include one or more execution objects (e.g., at least one of an icon, a widget, and a shortcut) corresponding to one or more applications. As a first input is received, the application guidance screen may be displayed. In one embodiment, the application guidance screen is displayed by showing the application guidance screen gradually from a left edge of the display. According to one embodiment, the application guidance screen may be displayed in a partial area of the home screen or the application execution screen.

Also, while in operation 303, the electronic device may generate a notification event indicating that new information is generated or received in association with at least one application execution object displayed on the application guidance screen. In this instance, the electronic device may display an object (e.g., an indicator) associated with the notification event overlapping or close to the at least one application execution object associated with the notification event.

In operation 305, the electronic device determines whether a second input is received on the application guidance screen.

When the determination shows that the second input is received, the electronic device proceeds with operation 307. When the second input is not received, the electronic device maintains the state of displaying the application guidance screen.

In operation 307, the electronic device outputs information related to the notification event that has occurred. According to one or more embodiments of the present disclosure, the electronic device may display the information related to the notification event on a preview screen on the currently displayed application guidance screen. Also, according to one embodiment, the electronic device may display brief information related to the notification event on the preview screen. When a predetermined gesture input or an input of selecting at least one piece of information displayed on the preview screen displaying the brief information is received, the electronic device may display detailed information corresponding to all displayed brief information, or to the selected brief information, on the preview screen. Also, according to one embodiment, when information related to the notification event is displayed on the preview screen, and when a predetermined gesture input or an input for selecting at least one piece of the displayed information is received, the electronic device may output information corresponding to the selected information or the information corresponding to the predetermined gesture. For example, when the selected information is audio information, the electronic device may output the audio information through a speaker such as playing back a few measures of a song. Also, for example, when the selected information is information associated with an application, such as a scheduler, few functions (e.g., a function of adding or deleting an event, or the like) of the scheduler may be provided on the preview screen so that the few functions may be used even though the application is not executed.

In operation 309, the electronic device determines whether a third input signal associated with selecting the information related to the notification event displayed on the preview screen is received.

When the determination shows that the third input is not received, the electronic device may continuously maintain the state of displaying the preview screen.

When the determination shows that the third input signal is received, the electronic device executes an application corresponding to the application execution object in which the event has occurred, in operation 311. In operation 311, when the application is executed, the electronic device displays an execution screen of the corresponding application in the display. Here, the execution screen of the application may be displayed in a partial area of the application guidance screen, or may be displayed by in the entire area of the display occupied by the application guidance screen, or may be displayed in substantially the entire area of the display. According to one or more embodiments, the electronic device may display received new information corresponding to the notification event which is selected by the third input on the execution screen of the application.

Based on the operation procedure of the electronic device of FIG. 3 as described above, a detailed method of providing information according to one or more embodiments of the present disclosure will be described with reference to attached drawings.

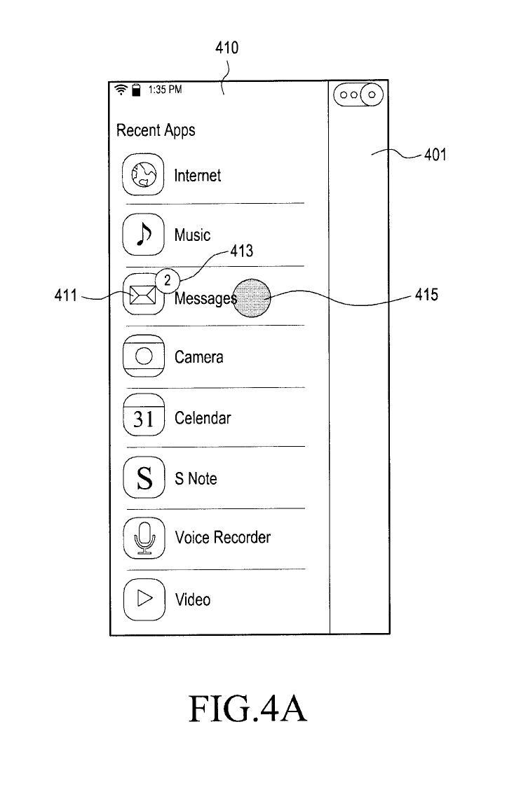

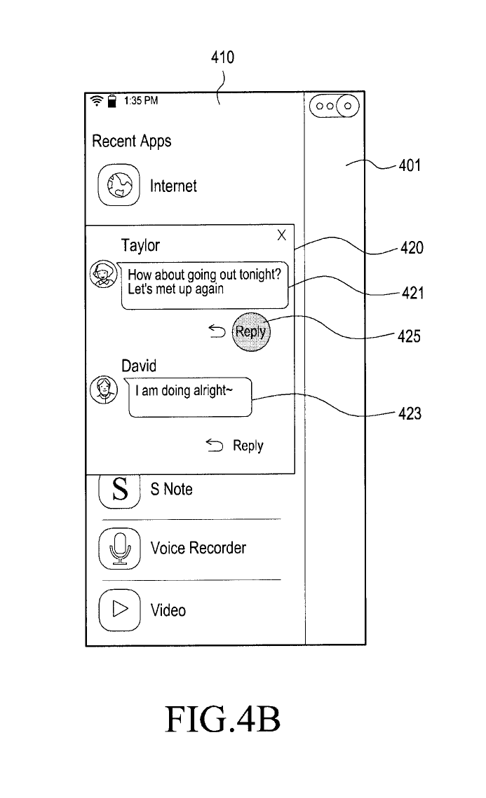

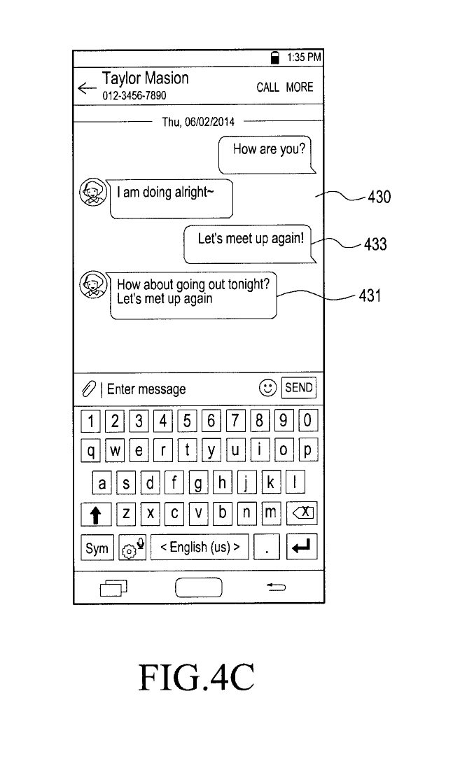

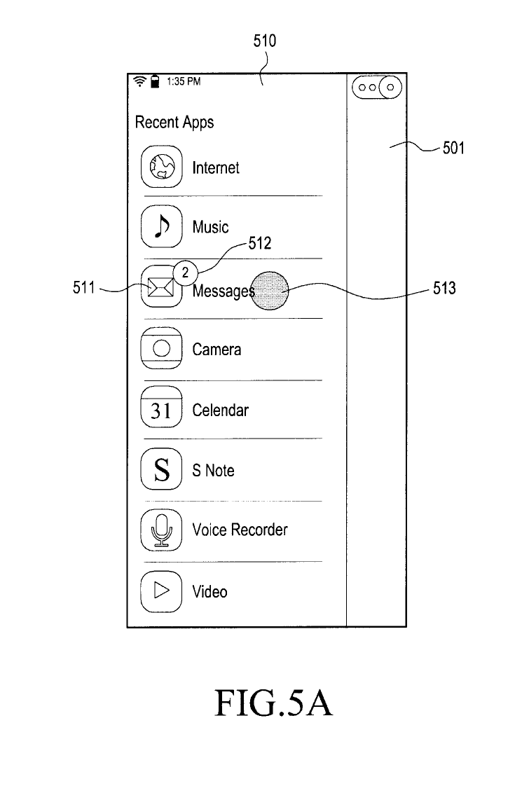

FIGS. 4A to 4C illustrate examples of screens of an electronic device according to one embodiment of the present disclosure.

Referring to FIG. 4A, when a first input (not shown) is received on a screen (e.g., a home screen 401) that is currently displayed in the display, the electronic device may display an application guidance screen 410 by gradually displaying the application guidance screen 410 from the left edge of the display so as to provide an effect in which the application guidance screen 410 appears on the left side and moves to the right.

To readily execute applications on the application guidance screen 410, the electronic device may display application execution objects (e.g., at least one of an icon, a shortcut image, and a widget) in the form of a list, and may move the display locations of the objects included in the list according to a scroll motion and may display the same. The application execution objects displayed on the application guidance screen may be displayed in various forms, in addition to the list.

Also, when new information associated with at least one application execution object 411 (e.g., a message) displayed on the application guidance screen 410 is received, the electronic device may generate a notification event associated with the new information, and may display an indicator 413 associated with the notification event so as to overlap or to be close to the at least one application execution object 411. Here, the indicator 413 may indicate the number of pieces of received new information (e.g., 2).

When a second input 415 associated with selecting the application execution object 411 is received on the application guidance screen 410, the electronic device may display a preview screen 420, as illustrated in FIG. 4B.

Referring to FIG. 4B, the electronic device may display the preview screen 420 in an area of the application guidance screen 410, and may display information (two messages 421 and 423) associated with the notification event on the preview screen 420. An object associated with a menu button (e.g., reply) that requests execution of an application associated with each message 421 and 423 may be displayed on the preview screen 420.

When a third input 425 associated with selecting the menu button is received as illustrated in FIG. 4B, the electronic device may execute an application corresponding to the application execution object 411 and may display an execution screen 430 of the executed application in the display, as illustrated in FIG. 4C. Here, the user may use the keyboard shown in FIG. 4C to enter a reply message 433 to be transmitted. Further, the execution screen 430 of the application may display a new message 431 received by a counter party in response to the reply message 433.

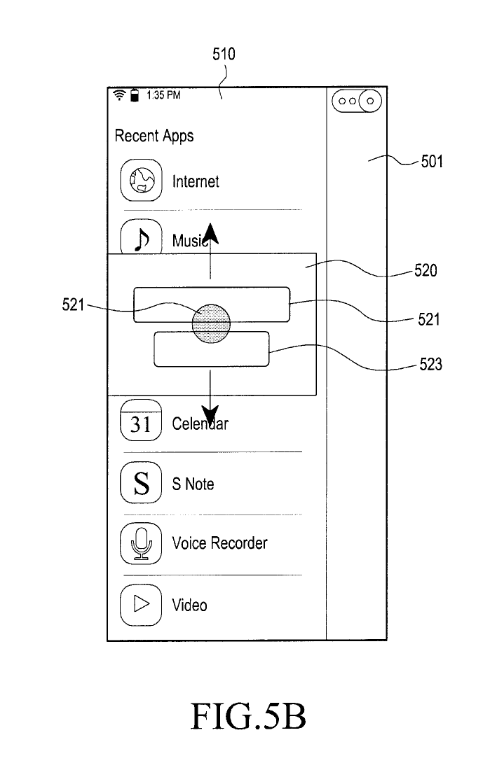

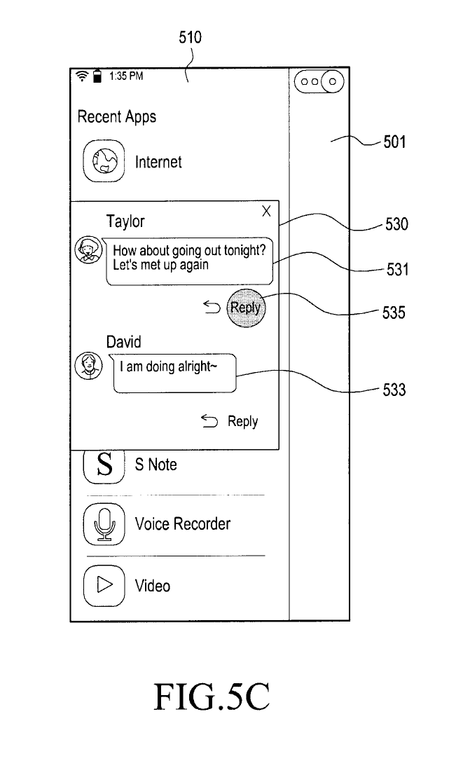

FIGS. 5A to 5D illustrate examples of screens of an electronic device according to one embodiment of the present disclosure.

An application guidance screen 510 of an electronic device as illustrated in FIG. 5A is configured and displayed in the same manner as the application guidance screen 410 as illustrated in FIG. 4A, and thus, a detailed description thereof will be omitted.

When a second input 513 associated with selecting a message-related application execution object 511 in which a notification event has occurred is received on the application guidance screen 510 as illustrated in FIG. 5A, the electronic device may display a preview screen 520 for displaying pieces of brief information 521 and 523 in advance of displaying an extended preview screen 530 as illustrated in FIG. 5C.

Also, when new information associated with at least one application execution object 511 (e.g., a message) displayed on the application guidance screen 510 is received, the electronic device may generate a notification event associated with the new information, and may display an indicator 512 associated with the notification event to overlap or to be close to the at least one application execution object 511. Here, the indicator 512 may indicate the number of pieces of received new information (e.g., 2).

Referring to FIG. 5B, the electronic device may display the preview screen 520 that displays notification event-related brief information 521 and 523 in an area of the application guidance screen 510, and may display notification event-related brief information (two pieces of brief message information 521 and 523) on the preview screen 520. When a predetermined gesture input 525 (e.g., a multi-touch input) is received on the preview screen 520, the electronic device may display an extended preview screen 530 that displays notification event-related detailed information 531 and 533 as illustrated in FIG. 5C. The application guidance screen 510 that displays the preview screen 530 of FIG. 5C is configured and displayed in the same manner as the application guidance screen 410, as illustrated in FIG. 4B, and thus, detailed descriptions thereof will be omitted.

When a third input 535 associated with selecting the menu button is received on the preview screen 530 of FIG. 5C, the electronic device may execute an application corresponding to the application execution object 511, and may display an execution screen 540 of the executed application, as shown in FIG. 5D. Here, the execution screen 540 is configured and displayed in the same manner as the execution screen 430 as illustrated in FIG. 4C, and thus, a detailed description thereof will be omitted.

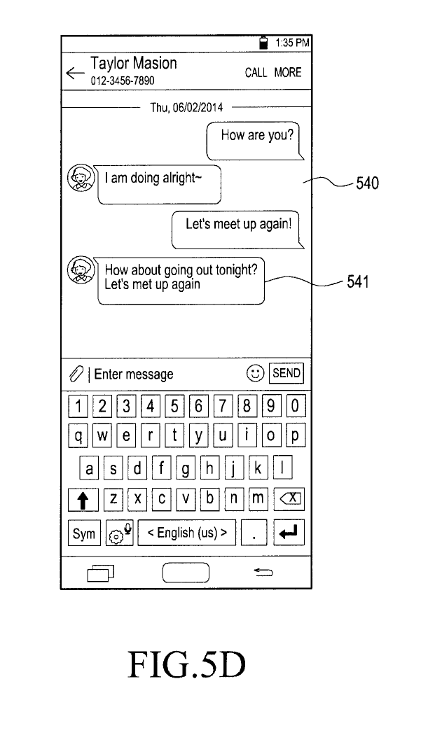

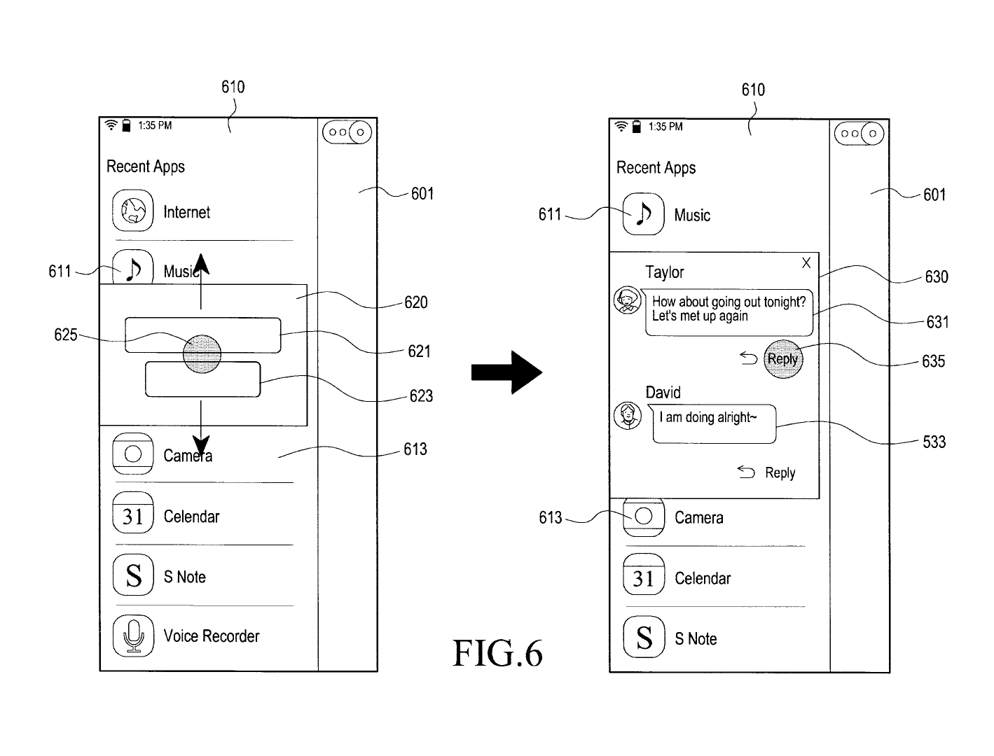

FIG. 6 illustrates an example of a screen of an electronic device according to one embodiment of the present disclosure.

Referring to FIG. 6, the electronic device may display a preview screen 620 including brief information 621 and 623, which is similar to the screen as illustrated in FIG. 5B. In this instance, the electronic device may rearrange display locations of application execution objects included in an application guidance screen 610 and may display the same so that other application execution objects (e.g., objects 611 and 613), which are displayed on the application guidance screen 610 but are not selected, are not covered or obscured by the preview screen 620. According to one embodiment, the application execution object 611 may be moved to an upper area where the preview screen 620 is not displayed. Also, the application execution object 613 may be moved to a lower area where the preview screen 620 is not displayed.

The electronic device may display a preview screen 630 that is extended from the preview screen 620 including detailed information 631 and 633, which is similar to the screen as illustrated in FIG. 5C. In this instance, in the same manner as described above, the electronic device may rearrange display locations of the application execution objects included in the application guidance screen 610 and may display the same so that other application execution objects (e.g., objects 611 and 613), which are displayed on the application guidance screen 610 but are not selected, are not covered by the preview screen 620. Similar to the screen illustrated in FIG. 5C, when a third input 635 for a menu button (reply) corresponding to the detailed event-related information 631 is received, the electronic device may display an execution screen of an application associated with the detailed event-related information 631.

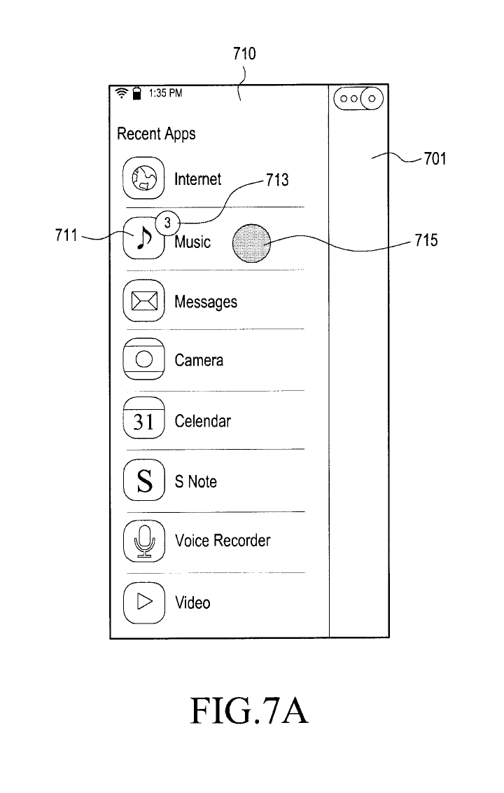

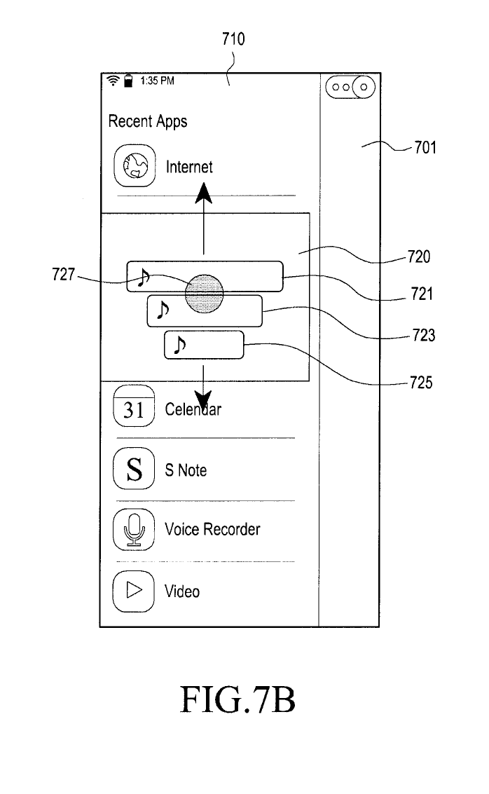

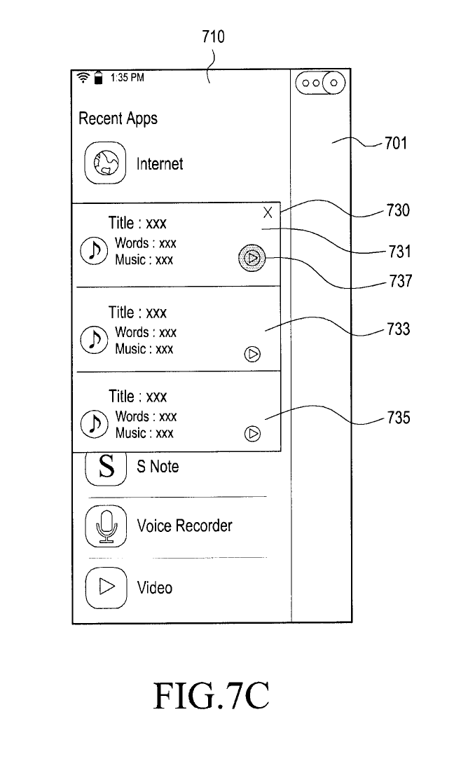

FIGS. 7A to 7C illustrate examples of screens of an electronic device according to one embodiment of the present disclosure.

An application guidance screen 710 of an electronic device as illustrated in FIG. 7A is configured and displayed in a similar manner as the application guidance screen 410 or 510 as illustrated in FIG. 4A or FIG. 5A, and thus, a detailed description thereof will be omitted. In an embodiment as illustrated in FIG. 7A, operation of an electronic device will be described in association with an embodiment in which new information is generated in a music-related application execution object 711.

When new information associated with at least one application execution object 711 (e.g., music) displayed on the application guidance screen 710 is received, the electronic device may generate a notification event associated with the new information, and may display an indicator 713 associated with the notification event to overlap or to be close to the at least one application execution object 711. Here, the indicator 713 may indicate the number of pieces of received new information (e.g., 3). For example, the indicator 713 may indicate 3 new songs that have been determined to be interesting to the user according to a user-selected criterion.

When the notification event has occurred for the music-related application execution object 711, and when a second input 715 associated with selecting the music-related application execution object 711 is received on the application guidance screen 710, as illustrated in FIG. 7A, the electronic device may display a preview screen 720 as illustrated in FIG. 7B. Referring to FIG. 7B, the electronic device may display the preview screen 720 for displaying notification event-related brief information 721, 723, and 725 in an area of the application guidance screen 710. When a predetermined gesture input 727 (e.g., a multi-touch input) is received on the preview screen 720, the electronic device may display an extended preview screen 730 that displays notification event-related detailed information 731, 733, and 735 as illustrated in FIG. 7C.

The application guidance screen 710 that displays the preview screen 730 of FIG. 7C is configured and displayed in a manner similar to the application guidance screen 410 or 510 as illustrated in FIG. 4B or FIG. 5C, and thus, a detailed description thereof will be omitted. Here, the electronic device may display a menu button (e.g., a shortcut key or a graphical user interface (GUI) such as an icon or the like) indicating execution of a function associated with each of the detailed information 731, 733, and 735 displayed on the preview screen 730. Here, when a third input 737 for selecting the menu button indicating execution is received, the electronic device may immediately execute a corresponding application linked to an execution menu. For example, in this case, if the third input 737 is received for detailed information 731, the electronic device may play back the audio file associated with detailed information 731.

When the third input 737 is received by selecting an execution menu for the notification event-related information displayed on the preview screen 730 of FIG. 7C, the electronic device may execute an audio reproduction-related application corresponding to the application execution object 711 in which the notification event has occurred, and may display an execution screen of the executed audio reproduction-related application. Also, the electronic device may display new information (e.g., a sound source) associated with the detailed information 731 corresponding to the execution menu selected by the third input 737 on the execution screen of the application, and may display other information such as album information associated with detailed information 731.

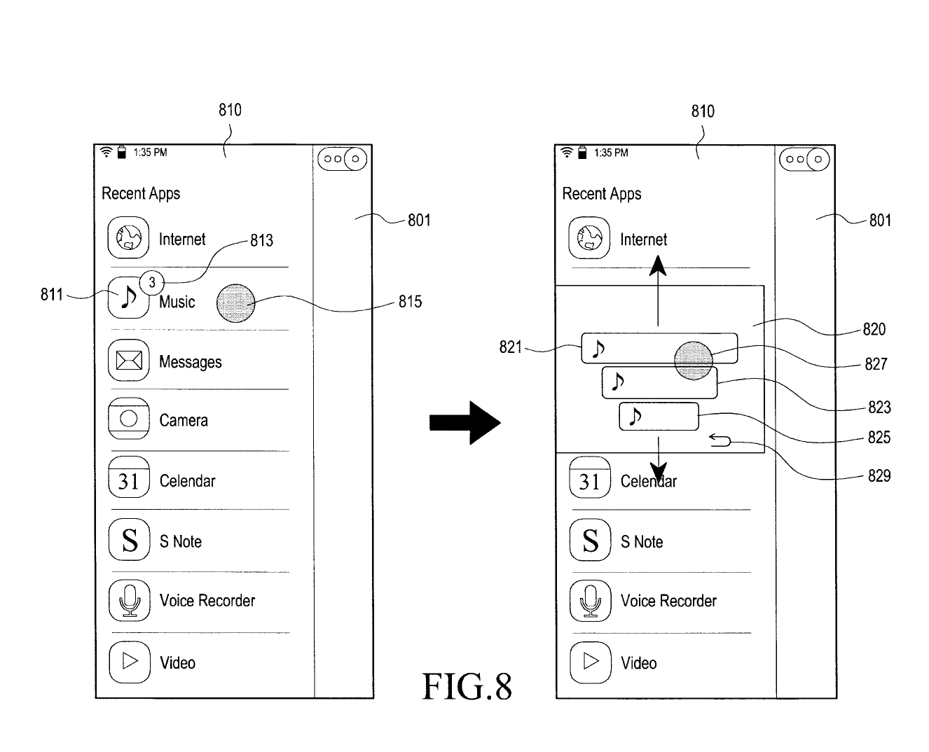

FIG. 8 illustrates an example of a screen of an electronic device according to one embodiment of the present disclosure.

The electronic device may display an indicator 813 associated with the notification event associated with at least one application execution object 811 (e.g., music player) displayed on the application guidance screen 810, to overlap or to be close to the at least one application execution object 811.

As illustrated in FIG. 8, when a second input 815 associated with selecting an audio-related (e.g., music-related) application execution object 811 is received on an application guidance screen 810, the electronic device may display a preview screen 820. The electronic device may display the preview screen 820 on the application guidance screen 810, and may display notification event-related brief information (three pieces of brief music information 821, 823, and 825) on the preview screen 820. When a predetermined gesture input 827 (e.g., a multi-touch input) is received on the preview screen 820, the electronic device may display the extended preview screen 730 that displays notification event-related detailed information 731, 733, and 735, as illustrated in FIG. 7C.

Also, according to one embodiment, when an input for a menu button 829 is received on the preview screen 820, the electronic device may immediately execute an application corresponding to the application execution object 811.

Also, according to one embodiment, when the predetermined gesture input 827 is received, the electronic device may not display the extended preview screen 730 as illustrated in FIG. 7C, but may immediately output audio information selected by the predetermined gesture input 827, for example, audio information corresponding to brief information 821, through an audio module without executing a corresponding application. Accordingly, in the state in which the audio information is output, the electronic device may display execution screens unrelated to the audio play back application, or maintain the display of the preview screen 820. Also, according to one embodiment, when the electronic device outputs the detailed information on the extended preview screen (extended preview screen 730 of FIG. 7), instead of executing a corresponding application, the electronic device may not delete but maintain the indicator 813 indicating a notification event in the application guidance screen 810, thereby processing the notification event as if the user had not checked the notification event. Also, according to one embodiment, after display brief or detailed information in a preview screen or an extended preview screen, the electronic device may delete the indicator 813, thereby processing the notification event as if a user had checked the notification event.

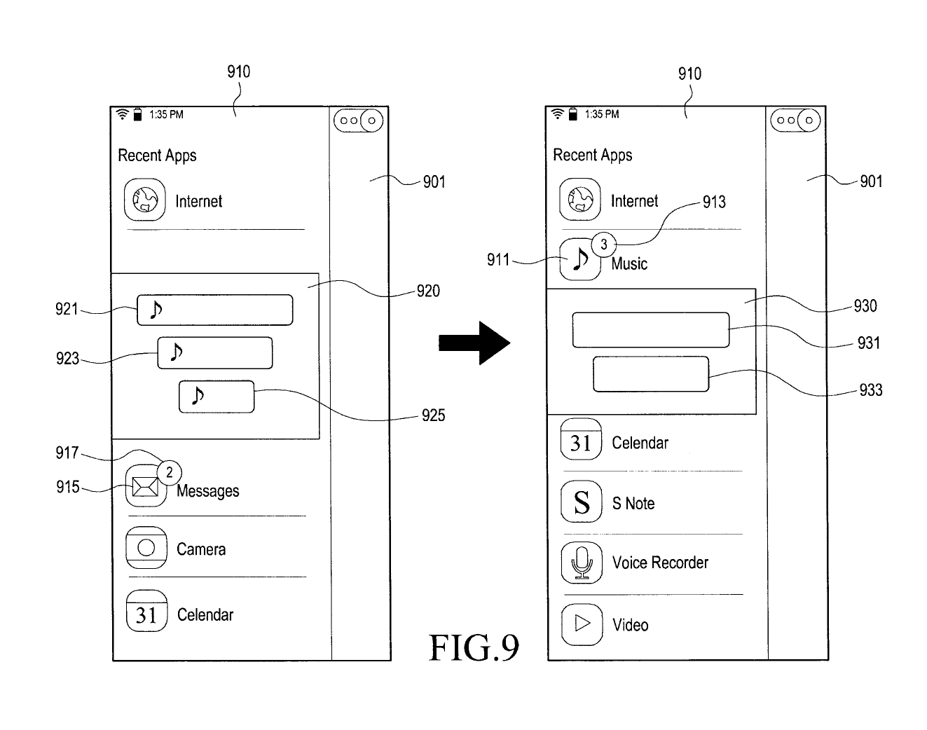

FIG. 9 illustrates an example of a screen of an electronic device according to one embodiment of the present disclosure.

Referring to FIG. 9, when an input associated with selecting a music-related application execution object is received on an application guidance screen 910, the electronic device may display a preview screen 920 including notification event-related brief information (e.g., three pieces of brief message information 921, 923, and 925). In this instance, when a notification event associated with another application execution object (e.g., a message application execution object 915) occurs in the application guidance screen 910, the electronic device may display an indicator 917 indicating that a notification event has occurred in the message application execution object 915.

When a second input associated with selecting the message application execution object 915 is received, the electronic device may convert the preview screen 920 to a new preview screen 930 including message-related brief information 931 and 932, and may display the same.

Also, according to one embodiment, the electronic device may display both the preview screen 920 related to music and the new preview screen 930 related to the message on the application guidance screen 910.

Also, according to one embodiment, for example, when a single touch is input in each of the preview screen 920 or the new preview screen 930, the electronic device may immediately execute the corresponding application. But when multiple touches are input, an extended preview screen for displaying event-related detailed information may be displayed.

According to one embodiment, when an input for selecting at least one application execution object included in an application execution guidance screen is, for example, a single touch, the electronic device may immediately execute a corresponding application.

A method of providing information in an electronic device according to any one of the embodiments of the present disclosure may include: displaying an application guidance screen including at least one application execution object corresponding to at least one application, in response to a first input; displaying a notification event for an application execution object from among the at least one application execution object; in response to a second input selecting the application execution object, displaying information related to the notification event on a preview screen; and in response to a third input selecting the information related to the notification event, executing an application corresponding to the application execution object.

According to one or more embodiments of the present disclosure, the method may further include displaying an execution screen of the application including new information corresponding to the information related to the notification event.

According to one or more embodiments of the present disclosure, the method may further include in response to a fourth input, displaying detailed information related to the notification event.

According to one or more embodiments of the present disclosure, the method may further include in response to the fourth input, displaying an extended preview screen where the detailed information related to the notification event is displayed, wherein the extended preview screen comprises one or more objects corresponding to one or more functions of the application.

According to one or more embodiments of the present disclosure, the method may further include when a plurality of application execution objects are displayed on the application guidance screen, rearranging a display location of at least one of the plurality of application execution objects that is covered by the preview screen.

According to one or more embodiments of the present disclosure, the method may further include: when another notification event occurs in a state in which the preview screen is displayed on the application guidance screen, determining another application execution object corresponding to the another notification event; displaying the another notification event for the another application execution object; and in response to a fifth input selecting the another application execution object, displaying information related to the another notification event on another preview screen.

According to one or more embodiments of the present disclosure, the another preview screen is displayed together with the preview screen.

According to one or more embodiments of the present disclosure, the method may further include: when the executed application is related to reproduction of audio information, playing back audio information associated with the notification event in a state in which the preview screen is displayed.

According to one or more embodiments of the present disclosure, the method may further include: when a single touch input selecting an application execution object from among the at least one application execution object is received on the application guidance screen, executing an application corresponding to the application execution object.

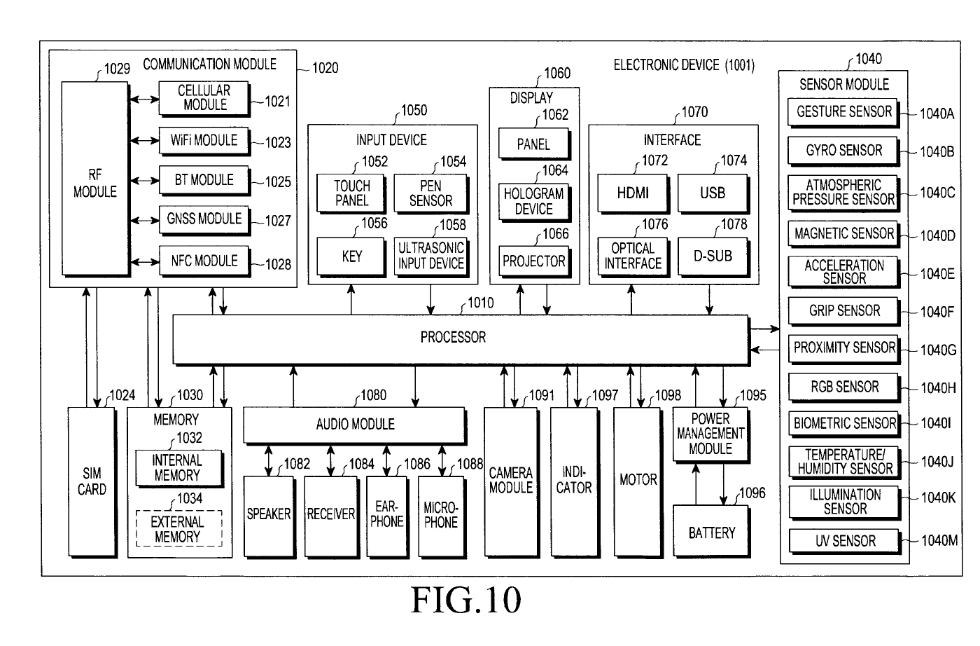

FIG. 10 is a block diagram of an electronic device according to one embodiment.

A part or the entirety of an electronic device 1001 may be included. The electronic device 1001 may include at least one processor 1010 (e.g., an AP), a communication module 1020, a subscriber identification module 1024, a memory 1030, a sensor module 1040, an input device 1050, a display 1060 (e.g., the display 160 of FIG. 1 or the display 250 of FIG. 2), an interface 1070, an audio module 1080, a camera module 1091, a power management module 1095, a battery 1096, an indicator 1097, and a motor 1098. The processor 1010 may control a plurality of hardware or software elements connected thereto and may perform various data processing and operations by driving an operating system or an application program. The processor 1010 may be embodied, for example, as a system on chip (SoC). According to an embodiment, the processor 1010 may further include a graphic processing unit (GPU) and/or an image signal processor. The processor 1010 may include at least some (e.g., a cellular module 1021) of the elements illustrated in FIG. 10. The processor 1010 may load, in a volatile memory, instructions or data received from at least one of the other elements (e.g., a non-volatile memory), process the loaded instructions or data, and store the resultant data in the non-volatile memory.

The communication module 1020 may have a configuration that is the same as, or similar to, that of the communication interface 170. The communication module 1020 may include, for example, a cellular module 1021, a WiFi module 1023, a Bluetooth module 1025, a GNSS module 1027, an NFC module 1028, and an RF module 1029. The cellular module 1021 may provide, for example, a voice call, a video call, a text message service, an Internet service, or the like through a communication network. According to an embodiment, the cellular module 1021 may identify and authenticate the electronic device 1001 within a communication network using the subscriber identification module 1024 (e.g., a SIM card). According to an embodiment, the cellular module 1021 may perform at least some of the functions that the processor 1010 may provide. According to an embodiment, the cellular module 1021 may include a communication processor (CP). According to some embodiments, at least some (e.g., two or more) of the cellular module 1021, the Wi-Fi module 1023, the BT module 1025, the GNSS module 1027, and the NFC module 1028 may be included in one Integrated Chip (IC) or IC package. The RF module 1029, for example, may transmit/receive a communication signal (e.g., an RF signal). The RF module 1029 may include, for example, a transceiver, a power amp module (PAM), a frequency filter, a low noise amplifier (LNA), an antenna, or the like. According to another embodiment, at least one of the cellular module 1021, the Wi-Fi module 1023, the BT module 1025, the GNSS module 1027, and the NFC module 1028 may transmit/receive an RF signal through a separate RF module. The subscriber identification module 1024 may include, for example, a card that includes a subscriber identification module, or an embedded SIM, and may contain unique identification information (e.g., an integrated circuit card identifier (ICCID)) or subscriber information (e.g., international mobile subscriber identity (IMSI)).

The memory 1030 (e.g., the memory 130) may include, for example, an embedded memory 1032 or an external memory 1034. The embedded memory 1032 may include, for example, at least one of a volatile memory (e.g., a DRAM, an SRAM, an SDRAM, and the like) and a non-volatile memory (e.g., a onetime programmable ROM (OTPROM), a PROM, an EPROM, an EEPROM, a mask ROM, a flash ROM, a flash memory, a hard disc drive, or a solid state drive (SSD)). The external memory 1034 may include a flash drive, for example, a compact flash (CF), a secure digital (SD), a Micro-SD, a Mini-SD, an eXtreme digital (xD), a multi-media card (MMC), a memory stick, and the like. The external memory 1034 may be functionally or physically connected to the electronic device 1001 through various interfaces.

The sensor module 1040 may, for example, measure a physical quantity or detect the operation state of the electronic device 1001, and may convert the measured or detected information into an electrical signal. The sensor module 1040 may include, for example, at least one of a gesture sensor 1040A, a gyro sensor 1040B, an atmospheric pressure sensor 1040C, a magnetic sensor 1040D, an acceleration sensor 1040E, a grip sensor 1040F, a proximity sensor 1040G, a color sensor 1040H (e.g., a red, green, blue (RGB) sensor), a biometric sensor 1040I, a temperature/humidity sensor 1040J, an illumination sensor 1040K, and a ultraviolet (UV) sensor 1040M. Additionally or alternatively, the sensor module 1040 may include, for example, an e-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 1040 may further include a control circuit for controlling at least one sensor included therein. According to an embodiment, the electronic device 1001 may further include a processor, which is configured to control the sensor module 1040, as a part of the processor 1010 or separately from the processor 1010, in order to control the sensor module 1040 while the processor 1010 is in a sleep state.

The input device 1050 may include, for example, a touch panel 1052, a (digital) pen sensor 1054, a key 1056, or an ultrasonic input device 1058. The touch panel 1052 may use, for example, at least one of a capacitive scheme, a resistive scheme, an infrared scheme, and an ultrasonic scheme. Furthermore, the touch panel 1052 may further include a control circuit. The touch panel 1052 may further include a tactile layer to provide a tactile reaction to a user. The (digital) pen sensor 1054 may include, for example, a recognition sheet that is a part of, or separate from, a touch panel. The key 1056 may include, for example, a physical button, an optical key, or a keypad. The ultrasonic input device 1058 may detect ultrasonic waves, which are generated by an input tool, through a microphone (e.g., a microphone 1088) to identify data corresponding to the detected ultrasonic waves.

The display 1060 (e.g., the display 160) may include a panel 1062, a hologram device 1064, a projector 1066, and/or a control circuit for controlling the same. The panel 1062 may be embodied to be, for example, flexible, transparent, or wearable. The panel 1062, together with the touch panel 1052, may be configured as one or more modules. According to an embodiment, the panel 1062 may include a pressure sensor (or a force sensor), which may measure the strength of pressure of a user's touch. The pressure sensor may be embodied as an integrated entity with the touch panel 1052 or may be embodied as one or more sensors separate from the touch panel 1052. The hologram device 1064 may show a three-dimensional image in the air by using the interference of light. The projector 1066 may display an image by projecting light onto a screen. The screen may be located, for example, in the interior of, or on the exterior of, the electronic device 1001. The interface 1070 may include, for example, an HDMI 1072, a USB 1074, an optical interface 1076, or a D-subminiature (D-sub) 1078. The interface 1070 may be included, for example, in the communication interface 170 illustrated in FIG. 1. Additionally or alternatively, the interface 1070 may include, for example, a mobile high-definition link (MHL) interface, an SD card/multi-media card (MMC) interface, or an infrared data association (IrDA) standard interface.

The audio module 1080, for example, may convert a sound into an electrical signal, and vice versa. At least some elements of the audio module 1080 may be included, for example, in the input/output interface 150 illustrated in FIG. 1. The audio module 1080 may process sound information that is input or output through, for example, a speaker 1082, a receiver 1084, earphones 1086, the microphone 1088, and the like. The camera module 1091 is a device that can photograph a still image and a moving image. According to an embodiment, the camera module 1091 may include one or more image sensors (e.g., a front sensor or a rear sensor), a lens, an image signal processor (ISP), or a flash (e.g., an LED or xenon lamp). The power management module 1095 may manage, for example, the power of the electronic device 1001. According to an embodiment, the power management module 1095 may include a power management integrated circuit (PMIC), a charger IC, or a battery or fuel gauge. The PMIC may use a wired and/or wireless charging scheme. The wireless charging scheme may include a magnetic-resonance scheme, a magnetic-induction scheme, an electromagnetic-wave scheme, and the like. Additional circuits (e.g., a coil loop, a resonance circuit, a rectifier, and the like) for wireless charging may be further included. The battery gauge may measure the remaining charge of the battery 1096 and a voltage, current, or temperature while charging. The battery 1096 may include, for example, a rechargeable battery and/or a solar battery.

The indicator 1097 may indicate a particular state (e.g., a booting state, a message state, a charging state, and the like) of the electronic device 1001 or a part (e.g., the processor 1010) thereof. The motor 1098 may convert an electrical signal into a mechanical vibration and may generate a vibration, a haptic effect, or the like. The electronic device 1001 may include a mobile TV support device (e.g., a GPU) that can process media data according to a standard, such as digital multimedia broadcasting (DMB), digital video broadcasting (DVB), mediaFlo™, or the like. Each of the above-described elements according to the present disclosure may be configured with one or more components, and the names of the corresponding elements may vary based on the type of electronic device. In various embodiments, an electronic device (e.g., the electronic device 1001) may omit some elements or may further include additional elements, or some of the elements of the electronic device may be combined with each other to configure a single entity, in which case the electronic device may perform the functions of the corresponding elements identical to that of the elements before combination.

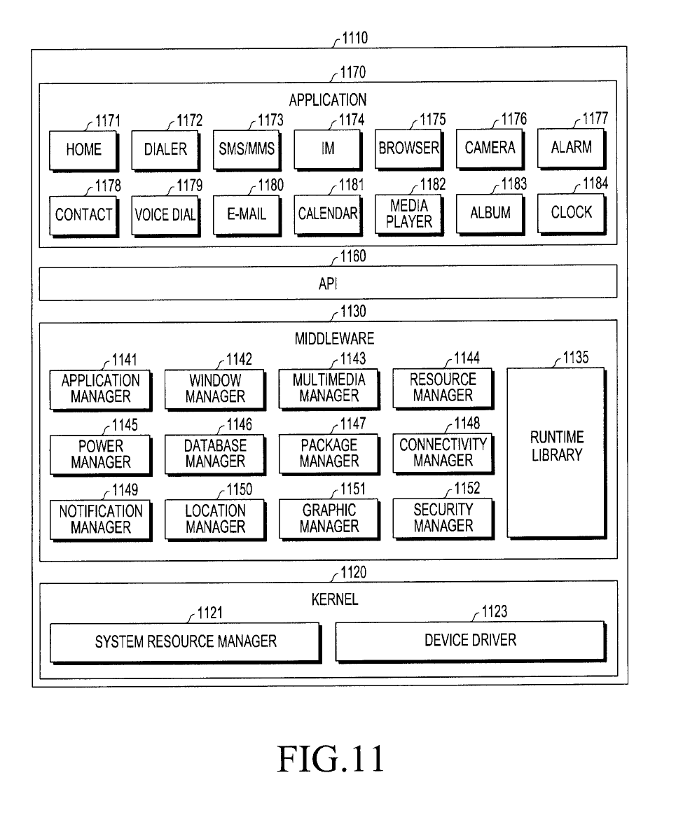

FIG. 11 is a block diagram of a program module according to one embodiment.

According to an embodiment, the program module 1110 (e.g., the program 140) may include an operating system that controls resources relating to an electronic device (e.g., the electronic device 101) and/or various applications (e.g., the application programs 147) that are driven on the operating system. The operating system may include, for example, Android™, iOS™, Windows™, Symbian™, Tizen™, or Bada™. Referring to FIG. 11, the program module 1110 may include a kernel 1120 (e.g., the kernel 141), middleware 1130 (e.g., the middleware 143), an API 1160 (e.g., the API 145), and/or applications 1170 (e.g., the application programs 147). At least a part of the program module 1110 may be preloaded on an electronic device, or may be downloaded from an external electronic device (e.g., the electronic device 102 or 104 or the server 106).

The kernel 1120 may include, for example, a system resource manager 1121 and/or a device driver 1123. The system resource manager 1121 may control, allocate, or retrieve system resources. According to an embodiment, the system resource manager 1121 may include a process manager, a memory manager, or a file system manager. The device driver 1123 may include, for example, a display driver, a camera driver, a Bluetooth driver, a shared memory driver, a USB driver, a keypad driver, a Wi-Fi driver, an audio driver, or an inter-process communication (IPC) driver. For example, the middleware 1130 may provide a function required by the applications 1170 in common, or may provide various functions to the applications 1170 through the API 1160 to enable the applications 1170 to use the limited system resources within the electronic device. According to an embodiment, the middleware 1130 may include at least one of a runtime library 1135, an application manager 1141, a window manager 1142, a multi-media manager 1143, a resource manager 1144, a power manager 1145, a database manager 1146, a package manager 1147, a connectivity manager 1148, a notification manager 1149, a location manager 1150, a graphic manager 1151, and a security manager 1152.

The runtime library 1135 may include, for example, a library module that a compiler uses in order to add a new function through a programming language while the applications 1170 are being executed. The runtime library 1135 may perform input/output management, memory management, or arithmetic function processing. The application manager 1141 may manage, for example, the life cycles of the applications 1170. The window manager 1142 may manage GUI resources used for a screen. The multimedia manager 1143 may identify formats required for reproducing various media files, and may encode or decode a media file using a codec suitable for a corresponding format. The resource manager 1144 may manage the source code of the applications 1170 or the space in memory. The power manager 1145 may manage, for example, the capacity or power of a battery and may provide power information required for operating the electronic device. According to an embodiment, the power manager 1145 may interoperate with a basic input/output system (BIOS). The database manager 1146 may, for example, generate, search, or change a database to be used by the applications 1170. The package manager 1147 may manage the installation or update of an application that is distributed in the form of a package file.

The connectivity manager 1148 may manage, for example, a wireless connection. The notification manager 1149 may provide an event (e.g., an arrival message, an appointment, a proximity notification, and the like) to a user. The location manager 1150 may manage, for example, the location information about the electronic device. The graphic manager 1151 may manage a graphic effect to be provided to a user and a user interface relating to the graphic effect. The security manager 1152 may provide, for example, system security or user authentication. According to an embodiment, the middleware 1130 may include a telephony manager for managing a voice or video call function of the electronic device or a middleware module that is capable of supporting a combination of the functions of the above-described elements. According to an embodiment, the middleware 1130 may provide specialized modules according to the types of operation systems. Furthermore, the middleware 1130 may dynamically remove some of the existing elements, or may add new elements. The API 1160 is, for example, a set of API programming functions, and may be provided in different configurations depending on an operating system. For example, in the case of Android or iOS, one API set may be provided for each platform, and in the case of Tizen, two or more API sets may be provided for each platform.

The applications 1170 may include, for example, home 1171, a dialer 1172, SMS/MMS 1173, instant messaging (IM) 1174, a browser 1175, a camera 1176, an alarm 1177, contacts 1178, voice dialing 1179, e-mail 1180, a calendar 1181, a media player 1182, an album 1183, a watch 1184, health care (e.g., measuring exercise quantity or blood glucose), an application for providing environment information (e.g., atmospheric pressure, humidity, or temperature information), and the like. According to an embodiment, the applications 1170 may include an information exchange application that can support the exchange of information between the electronic device and an external electronic device. The information exchange application may include, for example, a notification relay application for relaying predetermined information to an external electronic device or a device management application for managing an external electronic device. For example, the notification relay application may relay notification information generated in the other applications of the electronic device to an external electronic device, or may receive notification information from an external electronic device and provide the received notification information to a user. The device management application may install, delete, or update functions of an external electronic device that communicates with the electronic device (e.g., turning on/off the external electronic device itself (or some elements thereof) or adjusting the brightness (or resolution) of a display) or applications executed in the external electronic device. According to an embodiment, the applications 1170 may include applications (e.g., a health care application of a mobile medical appliance) that are designated according to the attributes of an external electronic device. According to an embodiment, the applications 1170 may include applications received from an external electronic device. At least some of the program module 1110 may be embodied (e.g., implemented) as software, firmware, hardware (e.g., the processor 120 of FIG. 1 or the processor 210 of FIG. 2), or a combination of at least two of them, and may include a module, a program, a routine, an instruction set, or a process for performing one or more functions.

The term “module” as used herein may include a unit consisting of hardware, software, or firmware, and may, for example, be used interchangeably with the term “logic”, “logical block”, “component”, “circuit”, or the like. The “module” may be an integrated component, or a minimum unit for performing one or more functions or a part thereof. The “module” may be mechanically or electronically implemented and may include, for example, an Application-Specific Integrated Circuit (ASIC) chip, a Field-Programmable Gate Arrays (FPGA), or a programmable-logic device, which has been known or are to be developed in the future, for performing certain operations. At least some of devices (e.g., modules or functions thereof) or methods (e.g., operations) according to various embodiments may be implemented by an instruction which is stored a computer-readable storage medium (e.g., the memory 130) in the form of a program module. The instruction, when executed by a processor (e.g., the processor 120), may cause the one or more processors to execute the function corresponding to the instruction. The computer-readable storage medium may include a hard disk, a floppy disk, a magnetic medium (e.g., a magnetic tape), an Optical Media (e.g., CD-ROM, DVD), a Magneto-Optical Media (e.g., a floptical disk), an inner memory, etc. The instruction may include a code made by a complier or a code that can be executed by an interpreter. The instruction may include a code made by a complier or a code that can be executed by an interpreter. The operations performed by modules, programming modules, or other elements according to various embodiments may be performed in a sequential, parallel, repetitive, or heuristic manner, and some of the operations may be performed in different orders or omitted, or other operations may be added.

According to one or more embodiments, there is provided a computer-readable recording medium having a program to be implemented recorded thereon. When the program is executed by a processor, the program may enable the processor to perform: displaying an application guidance screen including at least one application execution object corresponding to at least one application, in response to a first input; displaying a notification event for an application execution object from among the at least one application execution object; in response to a second input selecting an application execution object, displaying information related to the notification event on a preview screen; and in response to a third input selecting the information related to the notification event, executing an application corresponding to the application execution object.

Various embodiments disclosed herein are provided merely to easily describe technical details of the present disclosure and to help the understanding of the present disclosure, and are not intended to limit the scope of the present disclosure. Accordingly, the scope of the present disclosure should be construed as including all modifications or various other embodiments based on the technical idea of the present disclosure.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

What is claimed is:

1. An electronic device, comprising:
a display; and
a processor,
wherein the processor is configured to:
control the display to display an application guidance screen including at least one application execution object corresponding to at least one application, in response to a first input;
control the display to display a notification event for an application execution object from among the at least one application execution object;
in response to a second input selecting the application execution object, control the display to display information related to the notification event on a preview screen; and
in response to a third input selecting the information related to the notification event, execute an application corresponding to the application execution object.

2. The electronic device of claim 1, wherein, when the application is executed, the processor is further configured to control to display an execution screen of the application including new information corresponding to the information related to the notification event.

3. The electronic device of claim 1, wherein the processor is further configured to, in response to a fourth input, control the display to display detailed information related to the notification event.

4. The electronic device of claim 3, wherein the processor is further configured to, in response to the fourth input, control the display to display an extended preview screen where the detailed information related to the notification event is displayed, wherein the extended preview screen comprises one or more objects corresponding to one or more functions of the application.

5. The electronic device of claim 1, wherein, when a plurality of application execution objects are displayed on the application guidance screen, the processor is further configured to rearrange a display location of at least one of the plurality of application execution objects that is covered by the preview screen.

6. The electronic device of claim 1, wherein the processor is further configured to:
when another notification event occurs in a state in which the preview screen is displayed on the application guidance screen, determine another application execution object corresponding to the another notification event;
control the display to display the another notification event for the another application execution object; and
in response to a fifth input selecting the another application execution object, control the display to display information related to the another notification event on another preview screen.

7. The electronic device of claim 6, wherein the another preview screen is displayed together with the preview screen.

8. The electronic device of claim 1, wherein, when the executed application is related to reproduction of audio information, the processor is further configured to play back audio information associated with the notification event in a state in which the preview screen is displayed.

9. The electronic device of claim 1, wherein, when a single touch input selecting an application execution object from among the at least one application execution object is received on the application guidance screen, the processor executes an application corresponding to the application execution object.

10. A method of providing information in an electronic device, the method comprising:
displaying an application guidance screen including at least one application execution object corresponding to at least one application, in response to a first input;
displaying a notification event for an application execution object from among the at least one application execution object;
in response to a second input selecting the application execution object, displaying information related to the notification event on a preview screen; and
in response to a third input selecting the information related to the notification event, executing an application corresponding to the application execution object.

11. The method of claim 10, further comprising:
displaying an execution screen of the application including new information corresponding to the information related to the notification event.

12. The method of claim 10, further comprising:
in response to a fourth input, displaying detailed information related to the notification event.

13. The method of claim 12, further comprising:
in response to the fourth input, displaying an extended preview screen where the detailed information related to the notification event is displayed, wherein the extended preview screen comprises one or more objects corresponding to one or more functions of the application.

14. The method of claim 10, further comprising:
when a plurality of application execution objects are displayed on the application guidance screen, rearranging a display location of at least one of the plurality of application execution objects that is covered by the preview screen.

15. The method of claim 10, further comprising:
when another notification event occurs in a state in which the preview screen is displayed on the application guidance screen, determining another application execution object corresponding to the another notification event;
displaying the another notification event for the another application execution object; and
in response to a fifth input selecting the another application execution object, displaying information related to the another notification event on another preview screen.

16. The method of claim 15, wherein the another preview screen is displayed together with the preview screen.

17. The method of claim 10, further comprising:
when the executed application is related to reproduction of audio information, playing back audio information associated with the notification event in a state in which the preview screen is displayed.

18. The method of claim 10, further comprising:
when a single touch input selecting an application execution object from among the at least one application execution object is received on the application guidance screen, executing an application corresponding to the application execution object.

19. A computer-readable recording medium which records a program to be implemented on a computer, wherein the program includes one or more executable commands to enable a processor to perform operations when the program is executed by the processor, the operations comprising:
displaying an application guidance screen including at least one application execution object corresponding to at least one application, in response to a first input;
displaying a notification event for an application execution object from among the at least one application execution object;
in response to a second input selecting an application execution object, displaying information related to the notification event on a preview screen; and
in response to a third input selecting the information related to the notification event, executing an application corresponding to the application execution object.

20. The computer-readable recording medium of claim 19, wherein the operations further comprise:
in response to a fourth input, displaying detailed information related to the notification event.
